(19) United States
(12) Patent Application Publication
(10) Pub. No.: US 2003/0180517 A1
(43) Pub. Date: Sep. 25, 2003

(54) Material consisting of several layers for protecting parts of the body

(76) Inventor: Gerhard Karall, Neunkirchen (AU)

Correspondence Address: D Douglas Price, Steptoe & Johnson, 1330 Connecticut Avenue NW, Washington, DC, 20036, US

(21) Appl. No.: 10/221,207

(22) PCT Filed: Mar. 14, 2001
(86) PCT No.: PCT/AT01/00071

(30) Foreign Application Priority Data
Mar. 14, 2000 (AT) A 417/2000

(51) Int. Cl. B32B 3/00

(52) U.S. Cl. 428/304.4; 428/71

(57) ABSTRACT

The invention relates to a multilayered material for the protection of body parts from penetrating objects, such as, e.g., projectiles or splinters, comprising at least one energy-distributing layer (2) and at least one energy-absorbing layer (3), as well as a protective insert (1) for boots, a protective boot (8) and a protective outer garment by using such a multilayered material. To create such a material by which a good protective effect can be achieved with a simultaneous high elasticity, it is provided that the energy-absorbing protective layer (3), which, viewed in the direction of impact of the object, is arranged behind an energy-distributing layer (2), is made of a three-dimensional Polynorbonen-based matrix.

The invention relates to a multilayered material for the protection of body parts from penetrating objects, such as, e.g., projectiles or splinters, according to the preamble of claim 1, as well as a protective insert for boots, a protective boot and a protective outer garment by using such a multilayered material.

In many fields, a protection of body parts from penetrating objects is suitable. For instance, for roofing or also for the fire brigade, devices for protecting the feet, in particular the soles of the feet, from objects penetrating the boot are suitable and stipulated, respectively. In the respective standards (e.g. PrEN ISO 20344) the penetration safety for footwear is defined, and a limit value for the penetrating force is set at 1100 N.

Known protective inserts for boots protect the sole of the foot and/or the toe region of the foot. The corresponding protective inserts in most instances comprise a metal sole which effectively prevents the penetration of pointed or sharp objects, such as, e.g., nails or splinters. Yet such parts made, e.g., of spring steel plate, which are integrated into the sole construction increase the weight of the boot and lower the wearing comfort because of the restricted flexibility. For this reason, such boots or boot inserts have not been accepted by many groups of professions. Measures which increase the wearing comfort, such as, e.g., interruptions in the metal sole, reduce the protection, since objects may penetrate through the sole between the individual metal parts.

In U.S. Pat. No. 5,996,257 A, e.g., a puncture-resistant insole is described which comprises a synthetic material layer with metal inserts. The metal inserts cause a relatively high rigidity of the sole. Moreover, the arrangement of the metal plates often causes problems with the footwear.

To increase the flexibility, the construction according to U.S. Pat. No. 4,888,888 A includes a layer of stable material, e.g. a metal, consisting of a plurality of articulately interconnected individual parts. The expenditures for producing such a protective sole are relatively high.

EP 0,667,108 A1, e.g., describes a puncture-resistant sole for footwear which comprises the combination of a protective layer of a synthetic material with a flexible front part which, at its upper side, has a padding made of a fabric and, at its lower side, is connected with a further layer. The protective layer is, e.g., injection-molded of polyamide. Such soles are relatively stiff. To increase the movability, the thickness of the synthetic material layer is reduced, whereby, of course, also the protective effect is reduced.

Another field of application are protective boots, in particular boots against anti-personnel mines, worn by imperilled persons, particularly when clearing mine fields. The protective boots are to largely protect the wearer's legs from injury and even destruction, and to prevent as far as possible a bone fracture by energy impact.

In many countries of the earth, anti-personnel mines from past war activities constitute a great problem. Such anti-personnel mines are very cheap, simple to use and very difficult to detect, and they have disastrous effects on people if they detonate. The frequently occurring loss of limbs requires long rehabilitation of the victims which, due to the stays in a hospital or in a rehabilitation facility and the production of prostheses, also constitutes an enormous financial burden on the victim and on the state, respectively. At present, great attempts are made world-wide to free such states or regions from mines. At present, the persons performing this activity are only insufficiently protected from a destruction or injury of their legs. Presently available protective boots mostly have only a very insufficient wearing comfort or a very complex construction, making their production expensive, and moreover, their protective effect is insufficient.

U.S. Pat. No. 5,926,977 A describes a protective boot of multilayered structure which, by the use of selected materials, distributes and absorbs the explosion energy emanating from the land mine and thereby largely reduces the risk of an injury of the protective boot wearer's legs. The construction is characterized by a relatively low weight, high wearing comfort and an inexpensive production as well as a high safety. According to a preferred embodiment of the protective boot, the latter comprises an inner layer and an outer layer as well as a possible sole of rubber. The inner layer and the outer layer in turn are made up of layers of various materials. The inner layer is made of at least one layer of compressible, shock-absorbing material which is as light weight as possible, and which is surrounded by two layers, at least one of which is designed to be water-impermeable and the other one is designed to be puncture-resistant. The middle layer as well as the two outer layers of this inner layer in turn are preferably made up of several layers. At least one of the layers is built up of a flexible, heat-resistant, corrosion-resistant material, such as, e.g., glass fiber or ceramic fiber. For the build-up of the puncture-resistant layer, Kevlar®, e.g., is mentioned. According to another embodiment, the protective device consists of a box-type envelope into which the wearer introduces his/her foot through an upwardly arranged slot. However, such constructions have a relatively low wearing comfort and are not suitable to be worn over extended periods of time. This, in turn, reduces acceptance of the protective boots, and consequently increases the risk of injury. The protective layers are relatively thick (typically, in the range of a few centimeters), whereby the wearing comfort is markedly reduced. According to Example 1 of that patent specification, the boot protects against anti-personnel mines having a load of up to 150 g, with slight damage to the legs. It is, however, mentioned that slighter injuries, such as bruises or fractures, may occur.

A further embodiment of a protective boot against anti-personnel mines has been disclosed in U.S. Pat. No. 5,992,056 A. This construction comprises an insole which is insertable into a conventional boot. The sole is made up of a plurality of layers of highly resistant materials, such as, e.g., fabrics of Kevlar® or Spektra®. Such constructions do have a higher wearing comfort, yet their safety is insufficient.

A further embodiment of a mine-protection boot has been disclosed in GB 2,178,296 A, which is made up of a plurality of inflatable air cushions which are connected to a stable plate that is fastened to the sole of a boot. Each one of the air cushions communicates with at least one other cushion so that in case of an explosion of a land mine, the energy will be distributed over the entire protective layer. Such constructions have an extremely low wearing comfort and also a reduced safety.

A further field of use would be protective vests, in particular bullet-proof protective vests. Common constructions mostly consist of several layers of particularly dense aramide fiber fabric. U.S. Pat. No. 5,960,470 A, e.g., describes such a bullet-proof protective vest. An improved construction of a protective garment has been described in U.S. Pat. No. 6,000,055 A, wherein layers of a thermoplastic material are arranged between individual fabric or non-woven layers.

GB 2,124,887 A describes a multilayered material to be used in a protector so as to protect from projectiles, wherein, viewed in the direction of impact of the projectile, at first a water-proof layer, then several plastics layers, followed by a few sewed-together aramide fabric layers, followed by further aramide fabric layers, and a felt layer are arranged. By such a layered construction, however, insufficiently high passage forces have to be overcome by penetrating projectiles.

EP 564 249 A1 describes a material for protecting body parts from impacts, which material is made up of a sheet of a synthetic polymer, such as, e.g., polyurethane, polyethylene or polypropylene, and an inner sheet of a cross-linked visco-elastic material.

WO 97/43919 A1 shows a mine-protection boot whose sole is made up of several layers of aramide fabric, carbon fiber fabric or fabrics of ceramic fibers or glass fiber, and a further composite layer of woven aramide fibres and carbon fibers which are embedded in a polymer adhesive. An envelope of the upper boot between the outer and the inner leather layer consists of at least one layer of a fabric of ceramic or glass-ceramic fibers and at least one layer of aramide fabric. More precise details on the energy-absorbing protective layer are not disclosed in this document.

DE 44 02 465 C1 describes a device for protecting persons in mine fields, comprising a sub-structure for a footwear, which includes at least one layer of dampening material, e.g. polyethylene foam, and at least one layer for catching splinters, e.g. of fiber-reinforced synthetic materials, such as polyethelene with glass fiber fabric.

From EP 877 223 A2 a mine-protection device is known consisting of a hollow body which, e.g., has a triangular cross-section and is filled with a solid, liquid or gaseous substance. The body may comprise a valve via which a part of the energy derived from a blast wave can be discharged. The surfaces of the body may consist of a flexible or solid reinforcing layer.

Finally, WO 00/41583 A1 shows a puncture-resistant boot sole consisting of a plurality of fabric layers with a matrix arranged therebetween which serves to keep together the fabric layers and to restrict the shiftability of the individual fibers of the fabric layers. Polyethylene is preferably used as the material for this intermediate layer. The common thickness of the intermediate layer is stated to be 6.5 to 100 μm, and therefore the intermediate layer cannot be considered to be an energy-absorbing layer.

The present invention has as its object to provide a multilayered material of the above-indicated type, by which a good protective effect can be achieved for various applications, with a simultaneous high elasticity of the material. The production of the material is to be as simple as possible, and the disadvantages of known materials for protective devices are to be avoided or at least reduced.

The object according to the invention is achieved in that the energy-absorbing protective layer, which, viewed in the direction of impact of the object, is arranged behind an energy-distributing layer, is made of a three-dimensional Polynorbonen-based matrix. The matrix based on a Polynorbonen, such as, e.g., Astrosorb®, is characterized by a high energy-absorbing capacity and an appropriate elasticity. On account of its strength properties, the energy-distributing layer prevents the immediate penetration of the object by distributing the energy emanating therefrom as widely as possible. In this respect, there must not be any stretching ability which would cause an absorption of the energy. By combining the at least one energy-distributing layer with the at least one energy-absorbing layer, the energy level, starting from which the object penetrates the material, and thus the protective effect, is increased. On account of its special molecular structure, Polynorbonen has a high filling capacity for the most varying fillers, such as, e.g., special oils, silicates etc. By this—in contrast to e.g. caoutchouc, substantially better physical properties can be achieved.

In addition, a further energy-absorbing layer may consist of foamed elastomers, preferably of a nitrile-PVC foam or of foamed polyolefins. Such materials exhibit good shock-absorbing properties at favorable production an processing costs.

Advantageously, the energy-distributing layer is made of a fiber- or fabric-reinforced synthetic material, respectively. These fabrics or felts of fibers of all types with as high a strength as possible provide the material with the required dimensional stability and cause a distribution of the energy of penetrating objects. As fabrics, preferably aramide fabrics are employed which, for an optimum strength, suitably have as high a weft number as possible.

To prevent shifting of the layers of the multilayered material relative to each other, the layers may be fixedly interconnected, e.g. by gluing or sewing. Yet from the point of view of production technique, a connection may also be provided by vulcanizing or spraying.

To protect the arrangement and to stabilize it, respectively, particularly if the layers are only loosely interconnected, the layers may be surrounded by an envelope of a suitable material.

By embedding granules of a higher strength in the energy-absorbing layer, an energy consumption due to a friction of the object on the granules is achieved when objects penetrate. This results in an optimum protection from the penetration of pointed or sharp objects, with the flexibility of the multilayered material being simultaneously retained.

According to a further feature of the invention it is provided for the granules to consist of silicon carbide. Apart from such ceramic materials, also other materials may be used for these granules.

To attain as high a safety against the penetration in particular of pointed and sharp objects, it is provided for the volume portion of the granules in the energy-absorbing layer to be at least 30%.

The protective effect is increased in that several energy-distributing layers and energy-absorbing layers are alternatingly arranged.

The object of the invention is also achieved by a protective insert, in particular an insole for boots, characterised by a structure comprising the above-described multilayered material. In this manner, the sole of the foot can optimally be protected against an injury by penetrating pointed or sharp objects.

If at least one lateral lobe in the metatarsal region is connected at the rim-side with the multilayered material, the frequently endangered lateral region of the metatarsus can be appropriately protected in addition to the sole of the foot. By further lobes made of the multilayered material according to the above description, further zones, such as, e.g., the heel, can be protected. Advantageously, the lobe(s) is (are) produced with the insole in one piece. By using the material according to the invention, a three-dimensional shaping of the protective device is enabled. The protective insert can be inserted into a boot or also integrated in the boot.

Moreover, the object according to the invention is achieved by a protective boot, in particular a mine-protection boot, comprising a possibly reinforced outsole in which, above the outsole, at least partially a multilayered material described above is applied. By the inventive combination of the layer materials, an optimum protection of the foot and leg, respectively, from injury and destruction by exploding mines or other impacts can be achieved. Besides their use for imperilled persons in regions where mines have been laid, also protective boots e.g. for parachutists have to be mentioned. The use of the aforementioned multilayered material for a mine protection boot offers high safety and does not only prevent the destruction of the leg, but also its fracture by the energy impact of an exploding mine. What is sought is an absolute protection from injury in case of anti-personnel mines having a load size of up to 50 g of explosive. Moreover, also a very high wearing comfort is given so that the protective boots are accepted by the wearers and thus will always be worn during the dangerous service.

Advantageously, the energy-absorbing layer has a thickness of 10-14 mm, preferably 12 mm. Such a thickness offers an optimum protection and simultaneously guarantees a sufficient movability and, thus, a high wearing comfort. Tests have shown that with a layer thickness of 12 mm of Astrosorb®18, an introduced energy of 220 J is reduced to a transmittible force of less than 35 kN.

Optimum results for a mine protection boot are obtained if the multilayered material is comprised of at least four energy-distributing layers, and at least three energy-absorbing layers arranged between these energy-distributing layers.

To further increase the safety of the wearer's leg, an inner boot of fiber- or fabric-reinforced material may be provided.

If in this instance the inner boot is provided with an outsole, a separate boot can be created thereby which may, e.g., be worn during indoor service and when carrying out safe activities. If dangerous activities are carried out, such as the removal of land mines, the over-boot comprising the energy-distributing and energy-absorbing layers as well as the outsole, is put thereover.

To achieve an even higher protection of the foot, the multilayered material advantageously is extended upwards, laterally of the outsole, to a height of preferably 5 to 6 cm.

The object according to the invention is also achieved by a protective outer garment, in particular a protective vest, comprising the above-described multilayered material. An outer garment made in this manner is characterized by a high protective effect and, simultaneously, a high wearing comfort.

The present invention will be explained in more detail by way of the drawings which illustrate various exemplary embodiments of the invention. Therein,

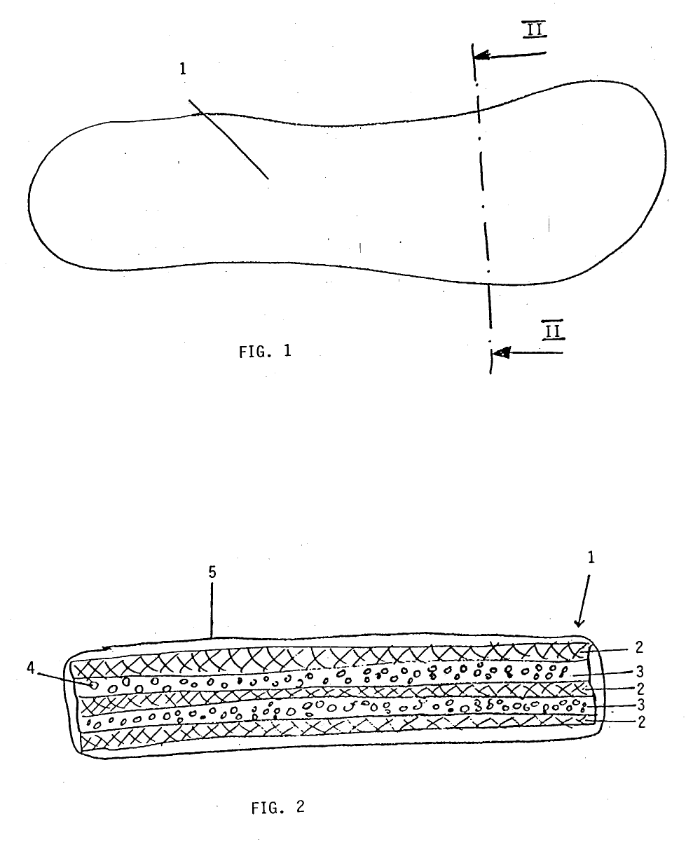

FIG. 1 shows a top view onto a protective insert in the form of a sole of a boot;

FIG. 2 shows a section through the protective insert according to FIG. 1, along section line II-II;

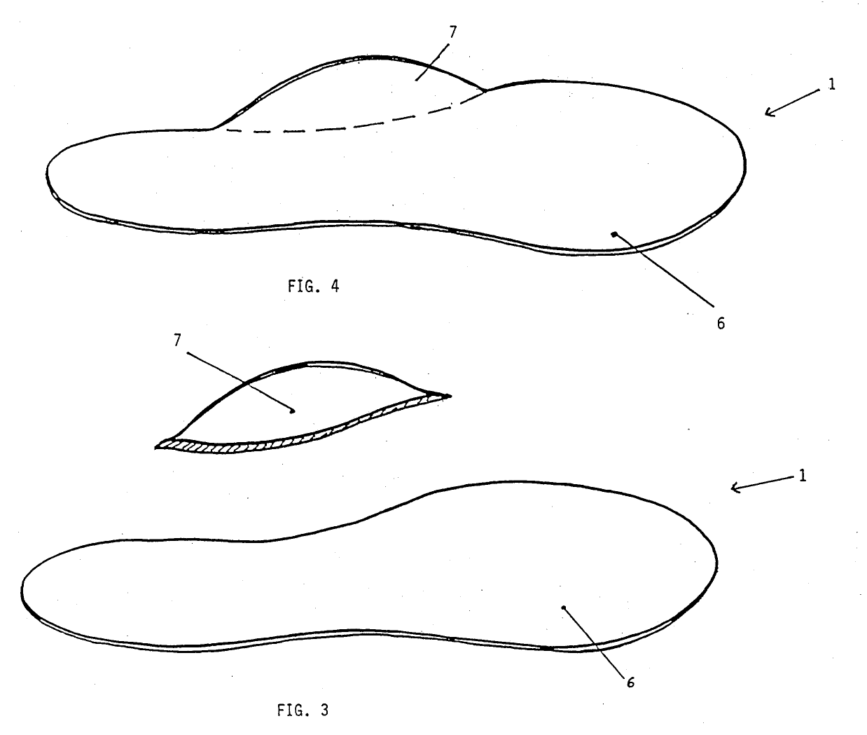

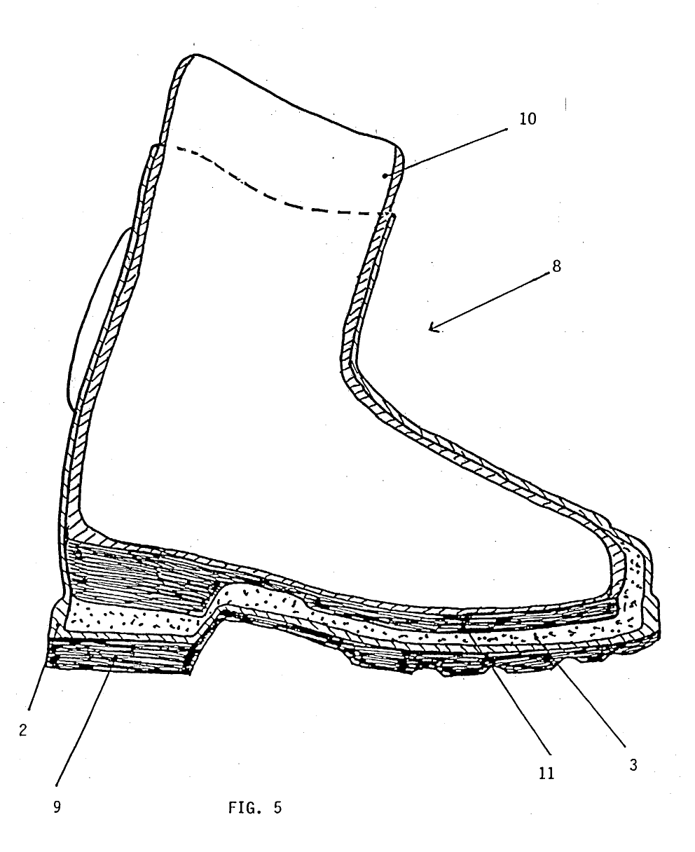

FIGS. 3 and 4 show perspective views of further embodiments of the protective insert for boots; and

FIG. 5 shows an application of the invention in a mine-protection boot.

FIG. 1 shows a protective insert 1 in the form of a sole of a boot, which can be inserted in a boot or integrated in the boot, and which is built up of the multilayered material according to the invention.

The sectional representation of the protective insert 1 according to FIG. 2 shows an embodiment of the invention consisting of a plurality of energy-distributing layers 2 and energy-absorbing layers 3 following each other. In the energy-absorbing layers 3, granules 4 may be embedded. Layers 2 which, advantageously, are made of a fiber fabric, e.g. of aramide fabric, provide the protective insert 1 with the respective dimensional stability and firmness against puncturing pointed and sharp objects. The fabric has as high a weft number as possible. According to the invention, at least one energy-absorbing layer 3 is made of a matrix based on Polynorbonen. When using an aramide fabric as the energy-distributing layer 2 and Polynorbonen as the energy-absorbing layer 3, the aramide fabric may be impregnated or passed by the composite of the Polynorbonen-matrix in the course of a vulcanizing procedure, and thus a safe connection of the layers 2, 3 can be obtained. The safety against puncturing objects is increased by the embedded fine-grain granules 4. By the granules 4 which advantageously are made of silicon carbide (korund) or similar materials, the energy of an object invading the multilayered material is consumed by friction and thus, a penetration of the object and an injury of the foot is efficiently prevented. For a sufficient friction, a volume portion of at least 30% of the granules 4 in layer 3 is suitable. With an optimum protective effect, the elasticity of the protective insert 1 is still maintained by the material combination according to the invention. The protective insert 1 preferably comprises a total of four layers. In addition, layers 2, 3 may be surrounded by an envelope 5. The aforementioned mandatory standard for protective boots for roofers or the like is met e.g. by a four-layer protective insert 1 having a total thickness of 3.5 mm.

FIG. 3 shows a perspective illustration of an embodiment of the invention, in which the protective insert 1 with the multilayered material according to the invention has the form of a sole 6 and a lobe 7. The lobe 7 may serve to protect the inner, lateral metatarsal region and be appropriately arranged within the boot and possibly fastened or installed during the production of the boot.

In the variant according to FIG. 4, the lobe 7 is fixedly connected to the sole 6, e.g. glued or sewed thereto. The sole 6 and the lobe 7 may also be produced in one piece and in one working procedure. By the inventive material combination of the energy-distributing layers 2 and the energy-absorbing layers 3, a three-dimensional shaping of the protective insert 1 for boots is possible which in the constructions used up to now has been impossible or possible to a limited extent only. The protective insert 1 according to the present invention is relatively inexpensive to produce, and therefore a boot can easily and inexpensively be adapted as a safety boot. By retaining the elasticity of the protective insert 1, a high acceptance is achieved.

A use of the protective insert according to the invention for boots is conceivable not only for roofers or for members of the fire brigade, but also for construction workers or for persons who deal with the removal of explosives.

FIG. 5 shows such an application of the multilayered material according to the invention in a protective boot 8, in particular a mine protection boot. The protective boot 8 against anti-personnel mines consists of an outsole 9 provided in conventional manner of rubber, possibly with a reinforcement, e.g. of steel plate. According to the invention, the protective boot 8 is provided with an energy-distributing layer 2 which preferably is made of fiber- or fabric-reinforced synthetic material. Behind the energy-distributing layer 2, viewed in the direction of impact of a penetrating object, an energy-absorbing layer 3 of a Polynorbonen-based matrix is arranged. Suitable commercially available materials are, e.g., Astrosorb® or Memory®. Instead of the layers 2, 3 illustrated, also several alternatingly arranged layers 2, 3 may be provided in appropriate thicknesses. The at least one energy-distributing layer 2 serves to distribute the directed explosion energy emanating from the land mine or from another source of energy and to thereby reduce the specific pressure. The energy-absorbing layer 3, or several such layers, respectively, serve to absorb the energy which passes through the layer 2 in distributed manner, and to convert the energy, e.g. into heat. In this manner, the energy which acts on the foot is substantially reduced, values of below 35 kN being striven for. By various combinations of materials and a multilayered structure, the effect can be further increased. Preferably, an inner boot 10 is arranged in the interior of the protective boot 8, which inner boot may be made of leather or, again, of a fiber- or fbric-reinforced material. If the inner boot 10 has a separate outsole 11, the former may also be used separate from the protective boot 8 as a fully functional boot, e.g. during safe activities or indoors. In the dangerous region, the outer boot is put on, and thereby the wearer receives optimum protection against anti-personnel mines. Although mainly protective boots against anti-personnel mines have been discussed, the protective boot 8 according to the invention may also be employed for other applications, such as, e.g., a boot for parachutists or as a protective boot for persons exposed to higher risks by blows or impacts on the feet. Moreover, use of the material according to the invention in boots for alpine mountaineering is also possible.

1. A multilayered material for the protection of body parts from penetrating objects, such as, e.g., projectiles or splinters, comprising at least one energy-distributing layer and at least one energy-absorbing layer, characterized in that the energy-absorbing protective layer (3), which, viewed in the direction of impact of the object, is arranged behind an energy-distributing layer (2), is made of a three-dimensional Polynorbonen-based matrix.

2. A multilayered material according to claim 1, characterized in that a further energy-absorbing layer (3) is made of foamed elastomers, preferably of a nitrile-PVC foam or of foamed polyolefins.

3. A multilayered material according to any one of claims 1 to 2, characterised in that the energy-distributing layer (2) is made of a fiber- or fabric-reinforced synthetic material, respectively.

4. A multilayered material according to claim 3, characterised in that the energy-distributing layer (2) is made of an aramide fabric.

5. A multilayered material according to any one of claims 1 to 4, characterised in that the layers (2, 3) are fixedly interconnected, e.g. by gluing or sewing.

6. A multilayered material according to any one of claims 1 to 5, characterised in that the layers (2, 3) are surrounded by an envelope (5).

7. A multilayered material according to any one of claims 1 to 6, characterised in that granules (4) are embedded in the energy-absorbing layer (3).

8. A multilayered material according to claim 7, characterised in that the granules (4) consist of silicon carbide.

9. A multilayered material according to claim 7 or 8, characterised in that the volume portion of the granules (4) in the energy-absorbing layer (3) is at least 30%.

10. A multilayered material according to any one of claims 1 to 9, characterised in that several energy-distributing layers (2) and energy-absorbing layers (3) are alternatingly arranged.

11. A protective insert, in particular an insole for boots, characterised by a structure comprising a multilayered material according to any one of claims 1 to 10.

12. A protective insert according to claim 11, characterised in that at least one lateral lobe (7) in the metatarsal region is connected at the rim-side with the multilayered material.

13. A protective boot, in particular a mine-protection boot, comprising a possibly reinforced outsole (9), characterised in that above the outsole (9) at least partially a multilayered material according to any one of claims 1 to 10 is applied.

14. A protective boot according to claim 13, characterised in that the energy-absorbing layer (3) has a thickness of 10-14 mm, preferably 12 mm.

15. A protective boot according to claim 13, characterised in that the multilayered material is comprised of at least four energy-distributing layers (2) and at least three energy-absorbing layers (3) arranged between these energy-distributing layers (2).

16. A protective boot according to any one of claims 13 to 15, characterised in that an inner boot (10) of fiber- or fabric-reinforced material is provided.

17. A protective boot according to claim 16, characterised in that the inner boot (10) is provided with an outsole (11).

18. A protective boot according to any one of claims 13 to 17, characterised in that laterally of the outsole (9), the multilayered material extends upwards to a height of preferably 5 to 6 cm.

19. Protective outer garment, in particular protective vest, comprising a multilayered material according to any one of claims 1 to 10.
